(19) United States
(12) Patent Application Publication
(10) Pub. No.: US 2022/0241631 A1
(43) Pub. Date: Aug. 4, 2022

(54) COMBINATION SPRINKLER HEAD ADAPTER

(71) Applicant: Tyco Fire Products LP, Lansdale, PA (US)

(72) Inventors: Steven Shields, Lubbock, TX (US); William K. Rucker, Lubbock, TX (US); Lyle Miller, Milford, CT (US); Kevin W. Pressnell, Athens, AL (US)

(73) Assignee: Tyco Fire Products LP, Lansdale, PA (US)

(21) Appl. No.: 17/626,593

(22) PCT Filed: Jul. 17, 2020
(86) PCT No.: PCT/IB2020/056765

§ 371 Date: Jan. 12, 2022

Related U.S. Application Data
(60) Provisional application No. 62/876,105, filed on Jul. 19, 2019.

(51) Int. Cl. A62C 35/68; F16L 13/02; B05B 15/658

(52) U.S. Cl. CPC A62C 35/68; B05B 15/658; F16L 13/0209

(57) ABSTRACT

A head adapter for a fire sprinkler includes a body defining a volume. The body includes an open first end that couples with a fluid supply line and provide fluid communication between the supply pipe and the volume of the body and an open second end that provides provide fluid communication between the volume of the body and the fire sprinkler. The second end includes a gasket. The body also includes a cap coupled with the second end of the body such that the gasket is disposed between the cap and the volume. The cap couples the body with the fire sprinkler to provide fluid communication between the fluid supply line and the fire sprinkler. The volume of the body is shaped such that fluid from the fluid supply line is directed to the fire sprinkler.

### CROSS-REFERENCE TO RELATED APPLICATIONS

The present application claims the benefit of and priority to U.S. Provisional Application No. 62/876,105, titled “COMBINATION SPRINKLER HEAD ADAPTER,” filed Jul. 19, 2019, the disclosure of which is incorporated herein by reference in its entirety.

### BACKGROUND

The present disclosure generally refers to an adapter for coupling a fluid supply line to a fire sprinkler. More specifically, the present disclosure refers to a head adapter that couples a fluid supply line to a concealed fire sprinkler within a wall.

### SUMMARY

At least one aspect of the present disclosure includes a head adapter for a fire sprinkler. The head adapter includes a body having a linear shape and defining a volume, with the body having an open first end that couples with a fluid supply line so as to provide fluid communication between the fluid supply line and the volume of the body, and an open second end that provides fluid communication between the volume of the body and the fire sprinkler, wherein the second end comprises a gasket. The head adapter also includes a cap coupled with the open second end of the body such that the gasket is disposed between the cap and the volume. The cap couples the body with the fire sprinkler to provide fluid communication between the fluid supply line and the fire sprinkler. The volume of the body accommodates movement of fluid from the fluid supply line to the fire sprinkler.

Another aspect of the present disclosure includes a shear joint facilitating coupling of the cap to the open second end of the body.

Another aspect of the present disclosure includes the open first end of the body having a diameter less than the diameter of the fluid supply line.

Another aspect of the present disclosure includes the open first end of the body having a diameter greater than the diameter of the fluid supply line.

Another aspect of the present disclosure includes the cap is coupled with the body via ultrasonic welding and comprises a threading for coupling to the fire sprinkler.

Another aspect of the present disclosure includes the fire sprinkler being a concealed fire sprinkler within a recess of a wall.

Another aspect of the present disclosure includes the open first end of the body coupled with the fluid supply line and the fluid supply line having a 1-inch diameter.

Another aspect of the present disclosure includes the open first end of the body coupled with the fluid supply line and the fluid supply line having a ¾-inch diameter.

At least one aspect relates to a sprinkler assembly. The sprinkler assembly includes a fire sprinkler, a fluid supply line, and a sprinkler adapter. The sprinkler adapter includes a body, a first opening, a second opening, and a cap. The body defines a volume. The first opening is coupled with the body and couples with the fluid supply line to provide fluid communication between the fluid supply line and the volume. The second opening is coupled with the body. The second opening provides fluid communication between the volume and the fire sprinkler. The second opening includes a gasket. The cap is coupled with the second opening such that the gasket is disposed between the cap and the volume. The cap couples the body with the fire sprinkler to provide fluid communication between the fluid supply line and the fire sprinkler. The volume accommodates movement of fluid from the fluid supply line to the fire sprinkler.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

FIG. 1 is a perspective view of a sprinkler head adapter, according to an example implementation.

FIG. 2 is a section view of the sprinkler head adapter of FIG. 1, according to an example implementation.

FIG. 3 is a perspective view of the sprinkler head adapter of FIG. 1 coupled with components of a fire protection system, according to an example implementation.

FIG. 4 is a perspective view of the sprinkler head adapter of FIG. 1, according to an example implementation.

FIG. 5 is a perspective view of an assembly fixture for use with the sprinkler head adapter of FIG. 1, according to an example implementation.

FIG. 6 is a perspective view of the sprinkler head adapter of FIG. 1 implemented in conjunction with the assembly fixture of FIG. 4, according to an example implementation.

FIG. 7 is a second perspective view of the sprinkler head adapter of FIG. 1 implemented in conjunction with the assembly fixture of FIG. 4, according to an example implementation.

FIG. 8 is a perspective view of the body of the sprinkler head adapter of FIG. 1, according to an example implementation.

FIG. 9 is a side view of the body of the sprinkler head adapter of FIG. 1, according to an example implementation.

FIG. 10 is a side view of the sprinkler head adapter of FIG. 1, according to an example implementation.

FIG. 11 is a second side view of the sprinkler head adapter of FIG. 1, according to an example implementation.

FIG. 12 is a third side view of the sprinkler head adapter of FIG. 1, according to an example implementation.

FIG. 13 is a side view of another aspect of a sprinkler head adapter, according to an example implementation.

FIG. 14 is a section view of the sprinkler head adapter of FIG. 13, according to an example implementation.

FIG. 15 is a perspective view of the sprinkler head adapter of FIG. 13 coupled with components of a fire protection system, according to an example implementation.

FIG. 16 is a second side of view of the sprinkler head adapter of FIG. 13, according to an example implementation.

FIG. 17 is a perspective view of the sprinkler head adapter of FIG. 13, according to an example implementation.

FIG. 18 is a perspective view of an assembly fixture to be implemented in conjunction with the sprinkler head adapter of FIG. 13, according to an example implementation.

FIG. 19 is a perspective view of the assembly fixture of FIG. 18 implemented in conjunction with the sprinkler head adapter of FIG. 13, according to an example implementation.

FIG. 20 is a section view of the assembly fixture of FIG. 18 implemented in conjunction with the sprinkler head adapter of FIG. 13, according to an example implementation.

FIG. 21 is a side view of a portion of the sprinkler head adapter of FIG. 13, according to an example implementation.

FIG. 22 is a second side view of a portion of the sprinkler head adapter of FIG. 13, according to an example implementation.

FIG. 23 is a perspective view of another aspect of a sprinkler head adapter, according to an example implementation.

FIG. 24 is a section view of the sprinkler head adapter of FIG. 18, according to an example implementation.

FIG. 25 is a perspective view of the sprinkler head adapter of FIG. 13 implemented in conjunction with a sprinkler, according to an example implementation.

FIG. 26 is a second perspective view the sprinkler head adapter of FIG. 13 implemented in conjunction with a sprinkler, according to an example implementation.

### DETAILED DESCRIPTION

Before turning to the figures, which illustrate certain examples, it should be understood that the present disclosure is not limited to the details or methodology set forth in the description or illustrated in the figures. It should also be understood that the terminology used herein is for the purpose of description only and should not be regarded as limiting.

Referring generally to the figures, fire suppression systems include sprinklers which can to inhibit or permit flow of fluid (typically water, but also in some applications fire suppressant fluid) depending upon conditions. In the instance of a fire, the sprinklers can to permit the flow of fluid such that the fluid may contact a deflector and be variously dispersed so as to subdue or prevent the spread of fire within a given area. For some areas, the sprinklers may be positioned within a wall (e.g., concealed sprinklers). In the instance of concealed sprinklers, there may be limited space for fluid supply lines, adapters, and other components within the concealed space such as a wall. Accordingly, it is desirable to maximize the flow of fire suppression fluid or other liquid to the concealed sprinkler despite space constraints within the concealed area. In order to achieve maximum possible flow to the sprinkler, it is desirable to use the largest possible fluid supply line within the limited area of the concealed space. Commonly, fluid supply lines are used in sizes that are smaller than desired due to sprinkler head adapters that occupy a large amount of the concealed space. For example, a 1-inch diameter pipe may be desirable for the sprinkler and appropriately sized for the concealed space, but may not be usable due to a sprinkler head adapter for the 1-inch diameter pipe being too large for the concealed space. Accordingly, sprinkler head adapters for concealed sprinklers that accommodate maximum possible pipe sizes and are of a size that may function appropriately within the concealed space are desirable.

The sprinkler head adapter described herein can include various configurations. The adapter includes various geometries and openings so as to accommodate one or more fluid supply lines, for example, to ensure flow of fire suppression fluid or other liquid to the concealed sprinkler. Additionally, the sprinkler head adapter described herein may include both linear and elbow-shaped geometries so as to accommodate various configurations of fluid supply lines and concealed spaces.

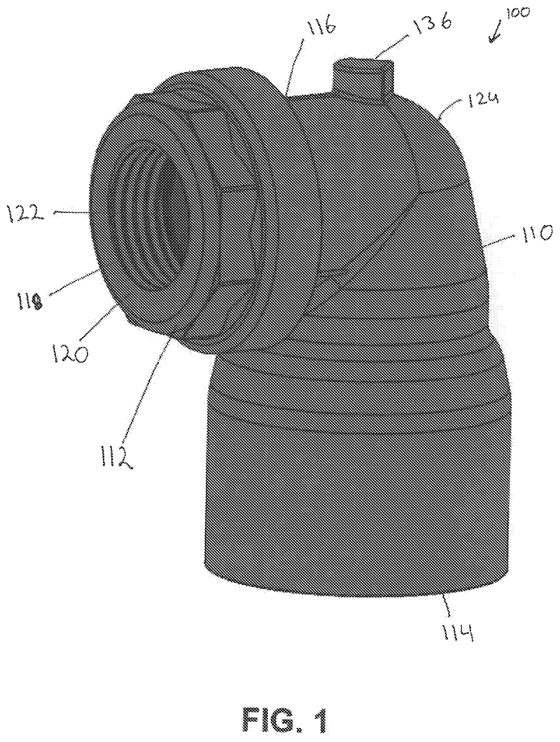

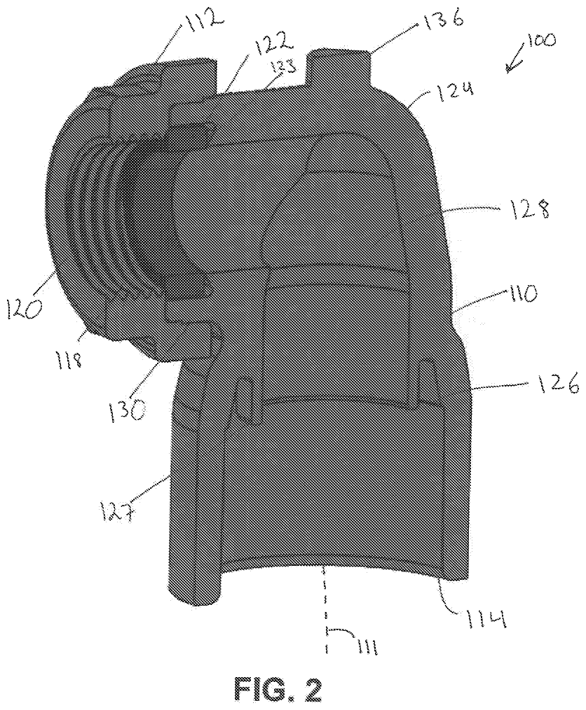

Referring now to FIGS. 1-3, an example sprinkler head adapter 100 is shown. The sprinkler head adapter 100 is shown to include a body 110, which has an elbow shape as indicated by an elbow 124 of the body 110. The body 110 of the sprinkler head adapter 100 includes a first opening 114 and a second opening 116, with the first opening 114 opposite the elbow 124 from the second opening 116. The body 110 is shown to be coupled at the second opening 116 to a cap 112, which can be coupled with the second opening 116 of the body 110 via a shear joint 130. The cap 112 may include one or more textures so as to facilitate gripping and manipulation by a user and/or tool. As shown in FIG. 2, the shear joint 130 includes a portion of the cap 112 having a greater interior diameter than the exterior diameter of the body 110 at the second opening 116. Accordingly, a portion of the body 110 can to be received by the cap 112 such that the second opening 116 is arranged within the cap 112. The shear joint 130 can be formed as a result of assembling the cap 112 and the body 110 of the sprinkler head adapter 100 using an ultrasonic welding process, although other assembly processes may also be implemented. For example, other assembly methods may include spin welding, gluing, or implementing a threaded joint. Accordingly, assembly of the cap 112 and the body 110 using alternative processes to ultrasonic welding may result in other various joints and/or couplings between the cap 112 and the body 110.

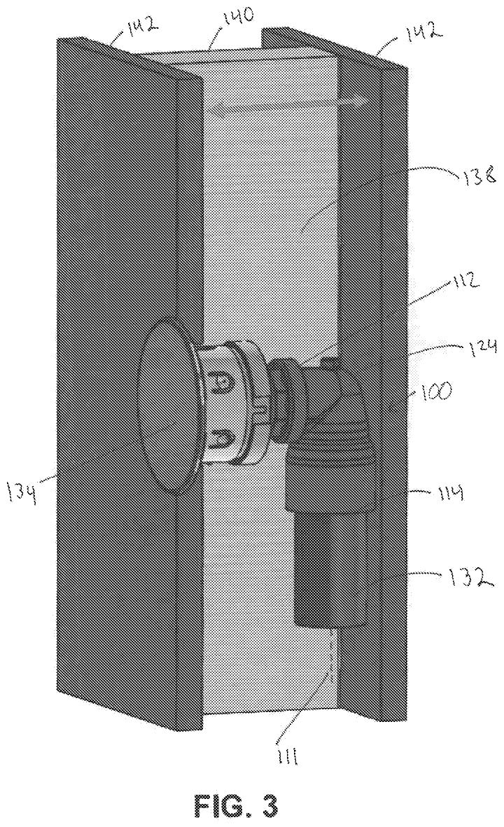

As shown in FIG. 2, the body 110 defines a volume 128, with the volume 128 extending from the first opening 114 to the second opening 116. As shown in FIGS. 1-3, the volume 128 includes an elbow shape similar to that of the body 110, but may also have other alternative geometries in other aspects of the sprinkler head adapter 100. For example, if the sprinkler head adapter 100 and the body 110 thereof included a substantially linear geometry between the first opening 114 and the second opening 116, the volume 128 would accordingly have a substantially linear geometry. The first opening 114 of the body 110 can to receive a fluid supply line 132 (e.g., a sprinkler system supply line), as shown in the example of FIG. 3. The fluid supply line 132 can be a portion of a sprinkler system for an area, such as a sprinkler supply line of a fire protection and/or suppression system, and can permit the flow of water or other liquids/fluids therethrough. The fluid supply line 132 can to have an outer diameter lesser than the interior diameter of the first opening 114 such that the fluid supply line 132 may be received by the first opening 114 and into the volume 128. In many fire suppression and fire protection applications, it is common for fluid supply lines such as fluid supply line 132 to have a 1-inch diameter. For example, if the fluid supply line 132 was a pipe having a 1-inch diameter (with the diameter being the outer diameter of the pipe), then the first opening 114 can have an interior diameter greater than 1-inch to as to accommodate the fluid supply line 132 and receive said fluid supply line 132 within a portion of the volume 128.

The body 110 is shown to include a groove 126 disposed within the body 110. As shown in the section view of FIG. 2, the groove 126 is circumferential about the inner surface of the body 110 and is defined by the inner surface of the body 110 and a notch 127. The groove 126 is shown to be positioned within the body 110 between the first opening and the elbow 124. Upon receiving the fluid supply line 132 through the first opening 114 and into the volume 128, the groove 126 and the notch 127 can to interface with the fluid supply line 132 about the inner surface of the body 110 so as to define an inserted position of the fluid supply line 132 within the volume 128 of the body 110. In some aspects, the groove 126 may include a gasket within at least a portion of the groove. In coupling the fluid supply line 132 to the body 110 of the sprinkler head adapter 100, glue or other bonding substances may be introduced so as to facilitate and promote longevity of the coupling between the fluid supply line 132 and the sprinkler head adapter 100. For example, a glue may be applied to the outer surface of the fluid supply line 132 and/or the inner surface of the body 110 between the first opening 114 and the groove 126. Upon reception of the fluid supply line 132 into the volume 128 of the body 110 via the first opening 114, the assembly including the sprinkler head adapter 100 and the fluid supply line 132 may be allowed time for the glue to cure such that the glue prevents backout of the fluid supply line 132 from the body 110 of the sprinkler head adapter 100.

The body 110 is shown to have a constant inner diameter between the first opening 114 and the groove 126 and the notch. However, as shown in the example of FIGS. 1-2, the body 110 is shown to narrow between the groove 126 and the notch 127, and the elbow 124. The narrowing of the body 110 corresponds to a reduction in both the interior and exterior diameters of the body 110 between the groove 126 and the elbow 124. The reduction of the inner and outer diameter of the body 110 between the groove 126 and the elbow 124 contours the body 110 inward toward a central axis 111, and the reduction of the diameters is symmetrical about said central axis 111. Accordingly, fluid passing through the fluid supply line 132 and into the volume 128 will flow from the fluid supply line 132 having a first diameter (within a portion of the volume 128 between the first opening 114 and the groove 126 having a diameter greater than that of the fluid supply line 132), for example 1-inch as discussed previously, to a portion of the volume 128 having a diameter less than or equal to that of the fluid supply line 132. In narrowing the diameter of the body 110 between the groove 126 and the elbow 124, the sprinkler head adapter 100 occupies less space within a concealed space 138 as shown in FIG. 3, which can be, for example, space within a wall between portions of drywall. Additionally, the narrowing of the body 110 between the groove 126 and the elbow 124 adjusts the flow of fluid from the fluid supply line 132 such that it may reach a sprinkler 134, which is shown in FIG. 3 to be coupled with the cap 112 of the sprinkler head adapter 100.

The sprinkler 134, as shown in FIG. 3, is coupled with the cap 112 of the sprinkler head adapter 100. In some aspects, the cap 112 may be of various sizes so as to accommodate various sprinklers 134. For example, a concealed sprinkler such as sprinkler 134 as shown in FIG. 3 may be available in various sizes in order to provide fire protection and/or suppression for various areas that may be storing various commodities. With reference to FIGS. 1-2, the cap 112 is shown to include a threading 118 on an interior surface of the cap 112. In some aspects, the threading may be ½-inch NPT threading, for example. The threading 118 of the cap 112 may vary according to some aspects so as to accommodate coupling with various sprinklers of different sizes and/or functions as discussed previously. In coupling with the sprinkler 134 as shown in FIG. 3, the threading 118 of the cap 112 can to interface with a complementary portion of the sprinkler 134 (e.g., opposite threading) so as to promote coupling and the formation of a seal between the cap 112 of the sprinkler head adapter 100 and the sprinkler 134. In some aspects, the sprinkler 134 may be coupled with the cap 112 using various thread sizes, a push-to-connect configuration, or other possible coupling means. In some examples, glue and/or other bonding agents may be introduced to the threading 118 and/or other portions of the cap 112 and/or sprinkler 134 similar to the interface of the fluid supply line 132 and the inner surface of the body 110 adjacent the first opening 114. Upon the introduction of such a glue and/or bonding agent, the sprinkler 134 and the sprinkler head adapter 100 may be left so as to allow for the glue and/or bonding agent to cure. Accordingly, the coupling of the cap 112 of the sprinkler head adapter 100 with the sprinkler 134 via the threading 118 (alone or in combination with a bondage agent) can such that any flow of fluid from the volume 128 of the body 110 to the sprinkler 134 occurs without leakage at the interface of the cap 112 and the sprinkler 134.

The sprinkler head adapter 100 is also shown to include a gasket 122, as shown in the example of FIG. 2. The gasket 122 may be comprised of polyurethane or other possible materials, and is arranged within a groove 123, with the groove 123 disposed between the cap 112 and the body 110, adjacent the second opening 116. As mentioned previously, the cap 112 is coupled with the body 110 of the sprinkler head adapter 100 via the shear joint 130. Accordingly, the arrangement of the gasket 122 at the interface of the cap 112 and the second opening 116 prevents leakage of any fluid passing from the volume 128 and to the sprinkler 134 via the second opening 116. As shown, the gasket 122 is disposed within the groove 123, which is in turn defined by the inner surface of the volume 128 between the second opening 116 and the elbow 124, and is more specifically defined by the inner surface adjacent the second opening 116. In some aspects, the gasket 122 may be positioned within the groove 123 prior to or after the formation of the shear joint 130 which, as discussed previously, may be formed by ultrasonic welding or other possible methods.

As shown in FIG. 3, the sprinkler 134 is positioned such that a portion of the sprinkler 134 extends through drywall 142, while the remainder of the sprinkler 134 can within the concealed area defined by the drywall 142 and the board 140. In some examples, the sprinkler 134 may be coupled with or positioned through other components defining alternative concealed areas such as the concealed space 138. Extending laterally from the sprinkler 134 is the sprinkler head adapter 100, with the cap 112 of the sprinkler head adapter 100 coupled with the sprinkler 134 and the body 110 coupled with the fluid supply line 132 at the first opening 114. For example, in many buildings it is standard for the concealed space 138 to be approximately 3.5-inches deep, with the depth shown as the space between the drywall 142. In the instance of a concealed sprinkler such as the sprinkler 134, most or all of the sprinkler 134 is recessed within the concealed space 138 leaving minimal space for fittings and adapters to facilitate fluid communication between the fluid supply line 132 and the sprinkler 134.

The sprinkler head adapter 100 as shown in FIG. 3 establishes fluid communication between the sprinkler 134 and the fluid supply line 132 within the concealed space 138. Said fluid communication is established via the coupling of the cap 112 to the sprinkler 134 and the coupling of the body 110 to the fluid supply line 132. In order to accomplish coupling within the concealed space 138, the sprinkler head adapter 100 includes the cap 112 and threading 118 adjacent the central axis 111 of the body 110. As shown in FIG. 3, the contour of the body 110, which is shown to decrease in diameter symmetrically about the central axis 111 between the groove 126 and the elbow 124, accommodates the configuration of the cap 112 adjacent the central axis 111. Accordingly, the sprinkler 134 is received by the sprinkler head adapter 100 at the cap 112 adjacent to the central axis 111, which is permitted by the contoured geometry of the body 110 as previously described.

Given the limited volume within the concealed space 138, it is common in the art for smaller components to be implemented in order to satisfy the constraints of the concealed space 138. For example, in some instances the fluid supply line 132 may be reduced from a standard 1-inch diameter pipe to a ¾-inch diameter pipe. Due to the decreasing pipe diameter, flow of fluid through the fluid supply line 132 is restricted and thus decreases the performance and fire protection/suppression potential of the sprinkler 134. For example, decreased fluid flow to the sprinkler 134 through a ¾-inch fluid supply line 132 may result in a smaller coverage area of the sprinkler 134. Accordingly, this smaller coverage area would result in a need for more sprinklers and, ultimately, greater cost for providing fire protection/suppression coverage for the area. Additionally, the implementation of ¾-inch pipes within the concealed space 138 also presents increased cost for providing fire protection/suppression for an area. For example, in many buildings 1-inch diameter pipe is a standard used throughout the building. If ¾-inch diameter pipe is implemented for the fluid supply line 132, this requires additional equipment and adapter components to transition from standard 1-inch pipes common throughout most buildings to ¾-inch pipes used as the fluid supply line 132 within the concealed space 138. With regard to the sprinkler head adapter 100, the design thereof accommodates a 1-inch diameter pipe as the fluid supply line 132 within the concealed space 138 as shown, thus reducing costs and increasing performance for providing fire protection/suppression for an area.

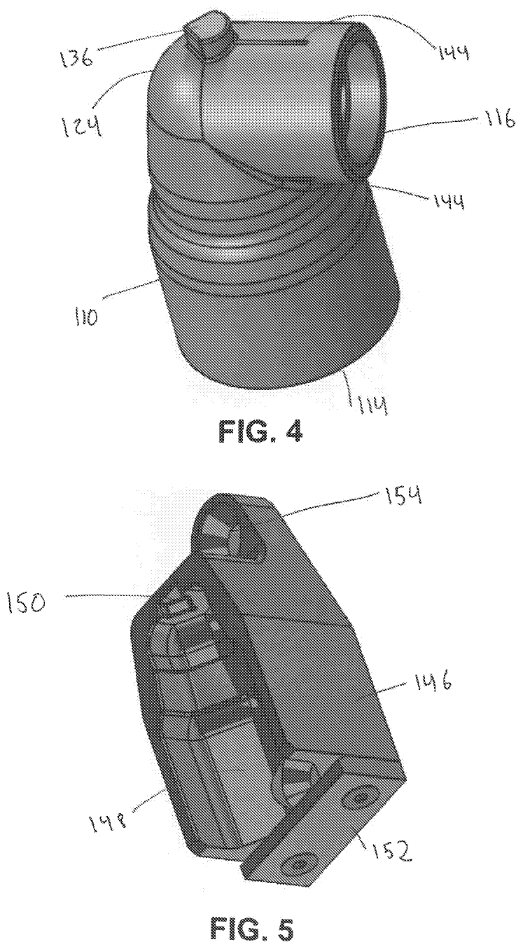

Referring now to FIG. 4, the sprinkler head adapter 100 is shown to include a locator lug 136 on the exterior surface of the body 110 adjacent the elbow 124. The locator lug 136 is shown to protrude orthogonally from the exterior surface of the body 110, and is further shown to include two sides forming a right angle at the portion of the locator lug 136 closest the elbow 124. In some aspects, the locator lug 136 may have alternative sizes and geometries from that shown in FIG. 4, such as, for example, a hexagonal shape as opposed to the three-sided configuration of the locator lug 136 of FIG. 4.

With reference to FIGS. 5-7, an assembly fixture 146 is shown. The assembly fixture 146 is shown to include a cavity 148, with the cavity 148 receiving the body 110 of the sprinkler head adapter 100 and retain and position of the body 110 during assembly processes. In some aspects, the assembly fixture 146 can be produced using injection molding, as well as other possible production techniques. The assembly fixture 146 is further shown to include a notch 150, with the notch 150 positioned within the cavity 148. The notch 150 is shown to have a geometry complementary to that of the locator lug of the body 110 of the sprinkler head adapter 100, and is arranged such that the locator lug 136 is received by the notch 150 when the body 110 of the sprinkler head adapter 100 is received in the cavity 148 of the assembly fixture 146. The assembly fixture 146 is also shown to include a plate 152 and a recess 154, as shown in FIG. 5. The plate 152 can to be coupled with the assembly fixture 146 so as to retain the body 110 of the sprinkler head adapter 100 within the cavity of the assembly fixture. As shown, the plate 152 is coupled with a portion of the assembly fixture adjacent the first opening 114 of the body 110 when the body 110 of the sprinkler head adapter 100 is disposed within the cavity 148 of the assembly fixture 146. The arrangement of the plate 152 thereby prevents backout of the body 110 of the sprinkler head adapter 100 from the cavity 148 of the assembly fixture 146. The recess 154 can opposite the assembly fixture 146 from the plate 152. The recess 154 is arranged to interface with one or more components implemented during manufacturing and/or assembly processes to facilitate manipulation and positioning of the assembly fixture. For example, a tool used in the manufacture or assembly of the body 110 of the sprinkler head adapter 100 can interface with the recess 154 so as to position the assembly fixture 146 for various operations such as, for example, ultrasonic welding.

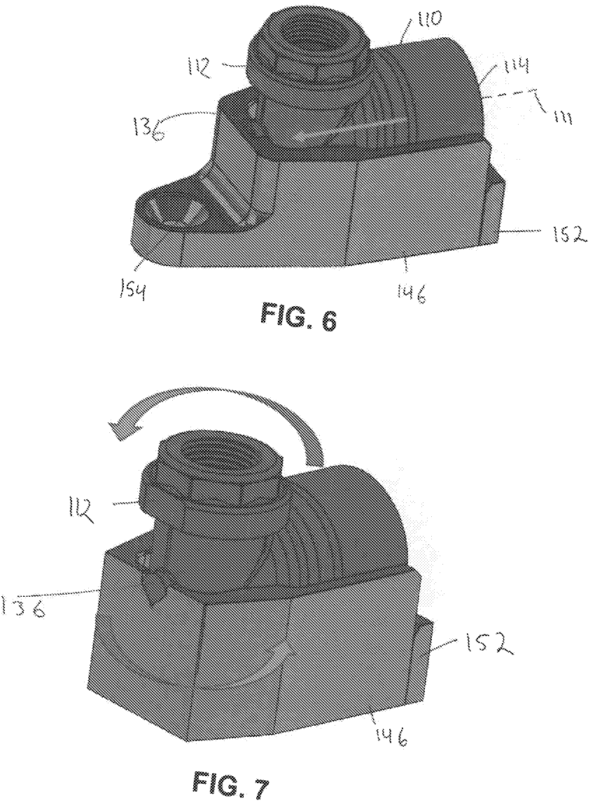

Referring now to FIGS. 6-7, the sprinkler head adapter 100 is shown to be received by the cavity 148 of the assembly fixture 146. The locator lug 136 is shown to be received by the notch 150 such that the body 110 is maintained in the orientation shown in FIGS. 6-7. As shown in FIG. 6, the plate 152 can adjacent the first opening 114 of the body 110 such that the sprinkler head adapter 100 is prevented from moving longitudinally along the central axis 111. With reference to FIG. 7, the locator lug 136 is shown to be positioned within the notch 150 of the assembly fixture 146. The locator lug 136 includes a right angle formed by two sides thereof, with said right angle facilitating the interfacing of the locator lug 136 and the notch 150. Additionally, the notch 150 is shown to surround at least a portion of the notch laterally so as to permit vertical reception of the sprinkler head adapter 100 into the cavity 148 as well as removal therefrom. The positioning of the sprinkler head adapter 100 within the assembly fixture 146, as shown in FIG. 7, prevents rotational movement of the sprinkler head adapter 100 in addition to preventing longitudinal movement as shown in FIG. 6. As described previously, the locator lug 136 may have various geometries in different aspects of the sprinkler head adapter 100, with the geometry of the notch 150 of the assembly fixture varying to correspond and facilitating interfacing with the locator lug 136.

The assembly fixture 146 is shown to retain the sprinkler head adapter 100 such that the cap 112 is directed upward relative to the central axis 111 and in a vertical direction substantially opposite the notch 150 relative to the locator lug 136. Accordingly, such a position can be conducive to manufacture and/or assembly of the sprinkler head adapter 100, such as, for example, ultrasonic welding of the cap 112 to the body 110. By retaining the sprinkler head adapter 100 or components thereof in such a position as shown in FIGS. 6-7, assembly and/or manufacturing processes may be both expedited and improved for accuracy. By retaining the sprinkler head adapter 100 and/or the body 110 is the set position as shown, assembly processes such as ultrasonic welding may be performed more efficiently and more accurately given a known and set position of the components to be assembled.

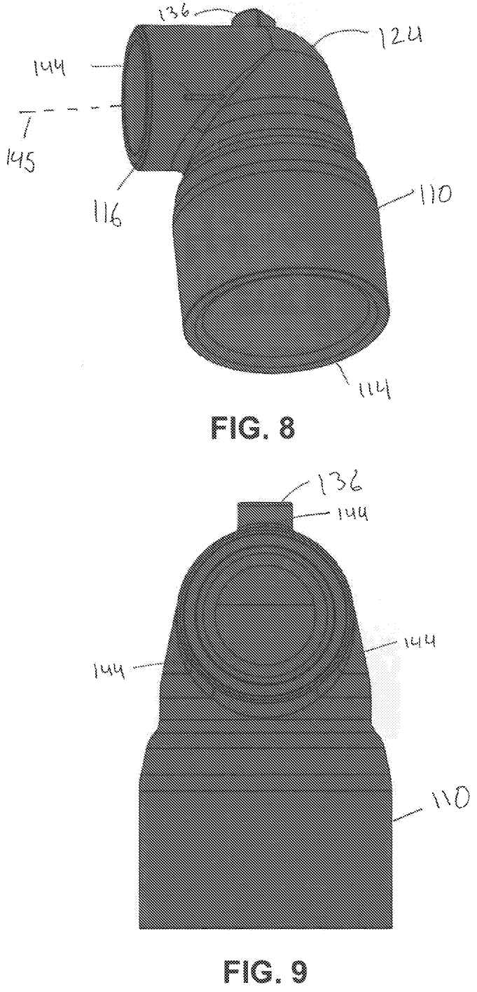

Referring now to FIGS. 8-9, the body 110 is shown to include verification indicators 144. The verification indicators 144 are shown to be disposed on the exterior surface of the body 110 between the elbow 124 and the second opening 116 adjacent a region to which the cap 112 will be coupled. As shown in FIG. 8, the verification indicators 144 can to be small lines protruding from the exterior surface of the body 110. The verification indicators 144 can, in some aspects, be introduced during manufacturing of the body 110. Additionally, the verification indicators 144 are disposed equidistant from the second opening 116 of the body 110. With reference to FIG. 9, the body 110 is shown to include a plurality of verification indicators 144 about the exterior surface of the body 110 disposed between the locator lug 136 and the second opening 116. In the example shown in FIG. 9, three verification indicators 144 can circumferentially about the exterior surface of the body 110. The three verification indicators 144 are disposed approximately 120° from one another, and thus establish three points defining a geometric plane with said geometric plane extending orthogonally to a central axis 145, shown in FIG. 8.

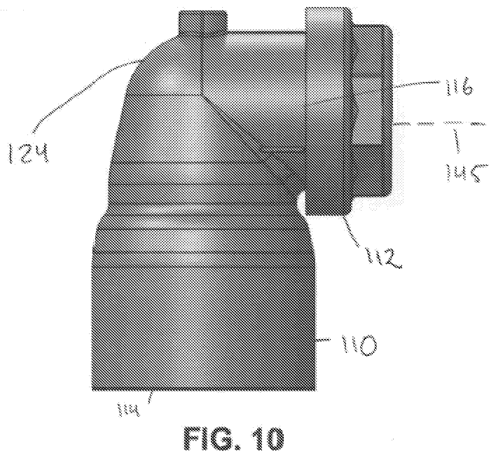

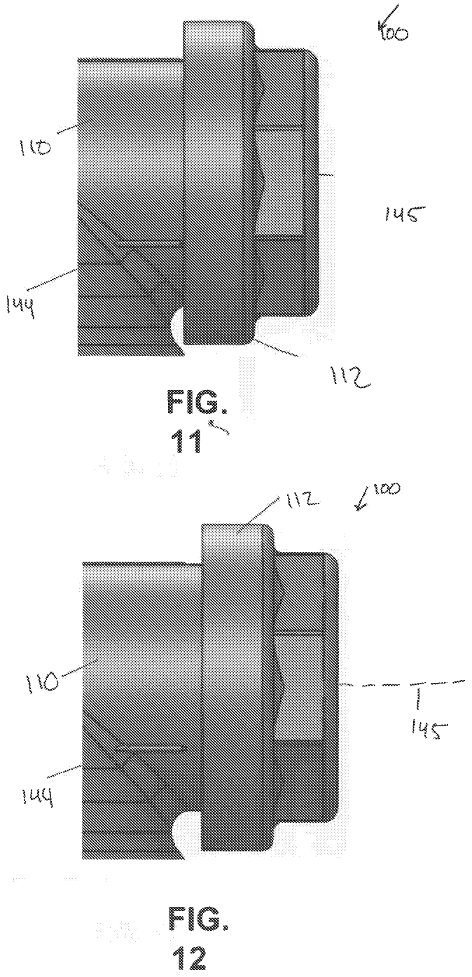

With reference to FIGS. 10-12, the sprinkler head adapter 100 is shown with the cap 112 coupled with the body 110. FIGS. 10-11 show the sprinkler head adapter 100 as properly assembled, which includes the verification indicators 144 directly adjacent the portion of the cap 112 positioned nearest the elbow 124 after assembly. Such positioning of the verification indicators 144 relative to the cap 112 after assembly (which may be performed by, for example, ultrasonic welding) is indicative of a proper assembly, with the cap 112 properly coupled with the body 110. It should be noted that, if any of the plurality of the verification indicators 144 is not in the proper position relative to the cap 112, then this can be indicative that the cap 112 and the body 110 are improperly assembled. The verification indicators 144 serve to expedite quality procedures in that measurement is not needed to determine if the cap 112 has been properly coupled with the body 110. The position of the verification indicators 144, if directly adjacent the cap 112 as shown in FIGS. 10-11, indicates that the cap 112 has been coupled with the body 110 in the proper position and thus assembled a proper sprinkler head adapter 100. Additionally, the verification indicators 144 serve to prevent any possible nonconforming sprinkler head adapters 100 from being installed and thus posing a risk of malfunction or lack of function.

Contrary to FIGS. 10-11, the example of FIG. 12 shows the verification indicator 144 not directly adjacent the cap 112 after assembly, thus indicating an improper assembly. As discussed previously, the body 110 can include a plurality of verification indicators 144 disposed about the outer surface of the body 110 between the elbow 124 and the second opening 116. As shown in FIG. 12, the portion of the cap 112 nearest the locator lug 136 and the elbow 124 is not positioned directly adjacent the verification indicator 144 and thus indicates that the sprinkler head adapter 100 has not been properly assembled. With regard to the example of FIG. 12, the verification indicators 144 can such that the assembly of the cap 112 and the body 110 to form the sprinkler head adapter 100 can be quickly examined.

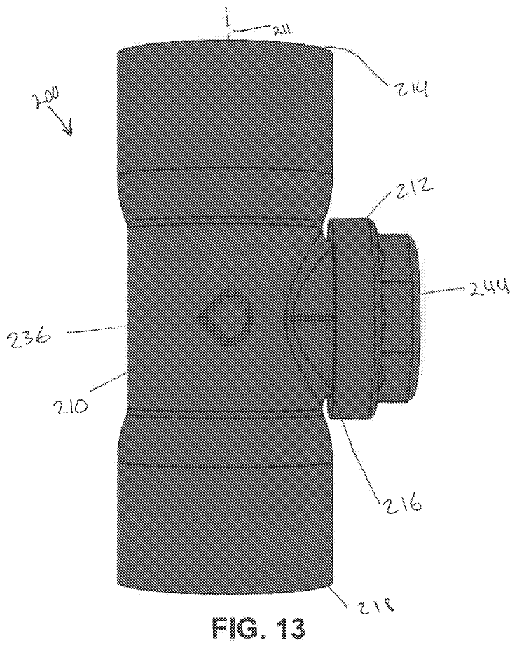

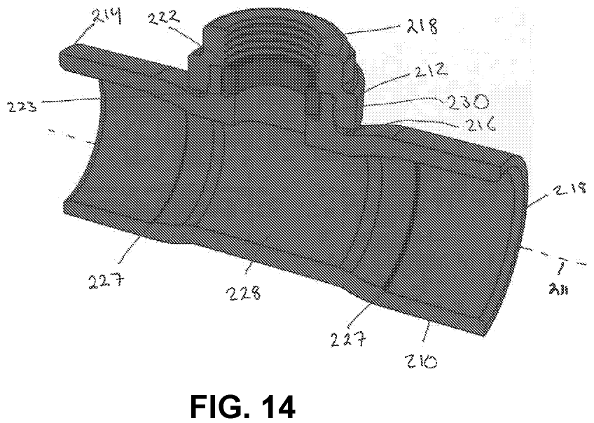

Referring now to FIGS. 13-17, a sprinkler head adapter 200 is shown. The sprinkler head adapter 200 is shown to include a body 210, with the body having a first opening 214, a second opening 216, and a third opening 218. The first opening 214 and the third opening 218 can substantially opposite the sprinkler head adapter 200 one another and, as shown in FIG. 13, are substantially 180° apart from one another. The body 210 is shown to extend between the first opening 214 and the third opening 218 and, as shown in FIG. 14, defines a volume 228. The volume 228 extends between the first opening 214 and the third opening 218 so as to provide fluid communication between the first opening 214 and the third opening 218. Additionally, the volume 228 provides fluid communication between the first opening 214, the third opening 218 the second opening 216, which can between the first opening 214 and the third opening 218 and is disposed on the body 210 substantially equidistant between the first opening 214 and the third opening 218.

The body 210 is shown to include a locator lug 236 extending from the exterior surface of the body 210 between the first opening 214 and the third opening 218, and is substantially equidistant therebetween. The body 210 can similar to the sprinkler head adapter 100 in that the body 210 can to narrow in both interior and exterior diameter along a central axis 211, with the reduction in diameter between the first opening 214 and the locator lug 236. Similarly, the body 210 can narrow in both interior and exterior diameter between the third opening 218 and the locator lug 236. The reduction of the diameter of the body 210 is symmetric about the central axis 211. Additionally, the body 210 can both between the locator lug 236 and the first opening 214, as well as between the locator lug 236 and the third opening 218, to receive a fluid supply line such as the fluid supply line 132 as shown and described previously. The body 210 can to receive a pair of fluid supply lines 232 in both the first opening 214 and the third opening 218, with the fluid supply lines being secured to prevent backout through a variety of means including but not limited to glue within the body 210 and/or on a surface of the fluid supply lines. The body also includes a pair of retention notches 127, which can be on the interior surface of the first and third openings of the body 214 and 218, respectively, and define an inserted position for the pair of fluid supply lines 232 within the body 210. In some aspects, the body may include one or more grooves similar to the groove of the sprinkler head adapter 100 so as to define an inserted position for the fluid supply lines within the body 210. Additionally, the combination of one or more of the grooves and, in some aspects, gaskets, can prevent leakage of any fluid moving from the fluid supply lines into the body 210 via the interface between the body 210 and the fluid supply lines.

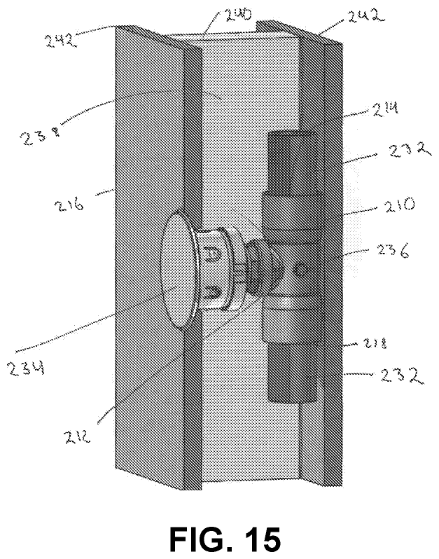

Similar to shown and described with regard to the sprinkler head adapter 100, the narrowing of the body 210 of the sprinkler head adapter 200 may facilitate placement of the sprinkler head adapter 200 in a concealed space 238 as shown in FIG. 15, as well as usage with concealed sprinklers such as a sprinkler 234 and one or more fluid supply lines 232. It should be noted that the concealed space 238 of FIG. 15 is shown to be the same size as the concealed space 138 of FIG. 3. Additionally, the fluid supply lines 232 as shown in FIG. 15 are shown to be the same as the fluid supply line 132 of FIG. 3. However, with regard to the concealed space 238 and the fluid supply lines 232, the specifications of said components may vary upon application and implementation, with specifications of the sprinkler head adapter 200 varying accordingly.

The second opening 216 of the body 210 is disposed between the first opening 214 and the second opening 216, and is further arranged entirely on a portion of the body 210 where the diameters of the body 210 have decreased. Similar to the sprinkler head adapter 100, the second opening of the sprinkler head adapter 200 can to interface with the cap 212. The cap 212 may be coupled with the body 210 at the second opening 216 via a shear joint 230 which may be the same as or similar to the shear joint 130 as shown and described with reference to the sprinkler head adapter 100, or other the coupling may include other possible coupling means including those described with reference to FIGS. 1-12. The body 210 is also shown to include a gasket 222 and groove 223 the same or similar to the gasket 122 and the groove 123 of the sprinkler head adapter 100, with the groove receiving and retaining the gasket 122. The gasket 222 can to prevent any leakage of fluid traveling from the body 210 to the cap 212. In some aspects, the cap may include a coupling means (e.g., threading, adhesive, boding agent, mechanical structure, etc.) to facilitate coupling to a sprinkler. The sprinkler 234 coupled with the cap 212 may be the same as or similar to the sprinkler 134 as shown in FIG. 3. The coupling of the sprinkler 234 to the sprinkler head adapter 200 permits the flow of fluid from the pair of fluid supply lines 232 (coupled with the body 210 at the first opening 214 and/or the third opening 218) to the sprinkler 234, which is facilitated by fluid communication permitting the flow of fluid through the body 210, through the second opening 216 and the cap 212, and to the sprinkler 234 so as to provide fire protection and/or suppression for an area.

With reference to FIG. 15, the body 210 of the sprinkler head adapter 200 receives the pair of fluid supply lines 232 in the first opening 214 and the third opening 218 such that the pair of fluid supply lines 232 can at least partially within the volume 228 of the body 210. As shown, the sprinkler 234 is coupled with the cap 212 within the concealed space 238 such that only a portion of the sprinkler extends through a piece of drywall 240, although in some aspects the concealed space 238 may be otherwise confined and defined. As shown in the example of FIG. 15, the pair of fluid supply lines 232 are 1-inch pipe, which is commonly found to be too large when serving as fluid supply for concealed sprinklers in small areas such as the concealed space 238. As shown and described previously, and similar to the configuration of the sprinkler head adapter 100, the narrowing of the diameter of the body 210 accommodates the cap 212 and, ultimately, the sprinkler 234 and the pair of fluid supply lines 232 within the concealed space 238.

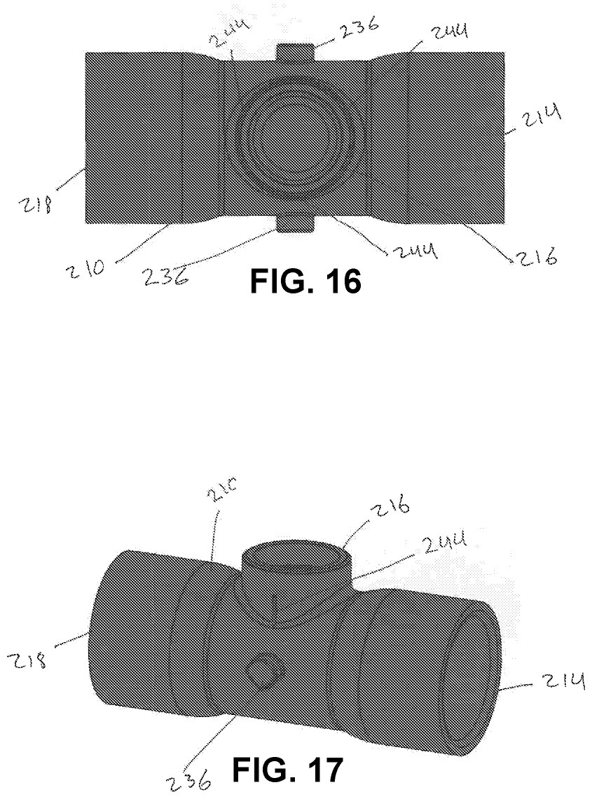

Referring now to FIGS. 16-17, the body 210 of the sprinkler head adapter 200 is shown to include verification indicators 244. As shown in FIGS. 13-15, the verification indicators can on an exterior surface of the body 210 between the locator lug and the second opening 216, and can such that the verification indicators 244 define a vertical plane. As shown in FIG. 16, the verification indicators 244 are disposed circumferentially about the body 210 adjacent the second opening 216 substantially 120° apart from one another. Such spacing facilitates the formation of the vertical plane, as previously shown and described with respect to the verification indicators 144 of the sprinkler head adapter 100. Additionally, in some aspects the body 210 of the sprinkler head adapter 200 may include multiple lug locators 236, as shown in FIG. 16. The locator lugs 236 may be used to position and retain the body 210 within an assembly fixture such as assembly fixture 246 in order to perform manufacturing and/or assembly operations. For example, the cap 212 may be coupled with the body 210 via ultrasonic welding or other processes while the body 210 is retained within the fixture plate, the fixture plate have a cavity and notch with geometry corresponding to that of the body 210.

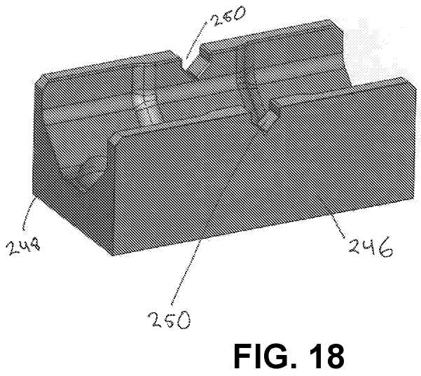

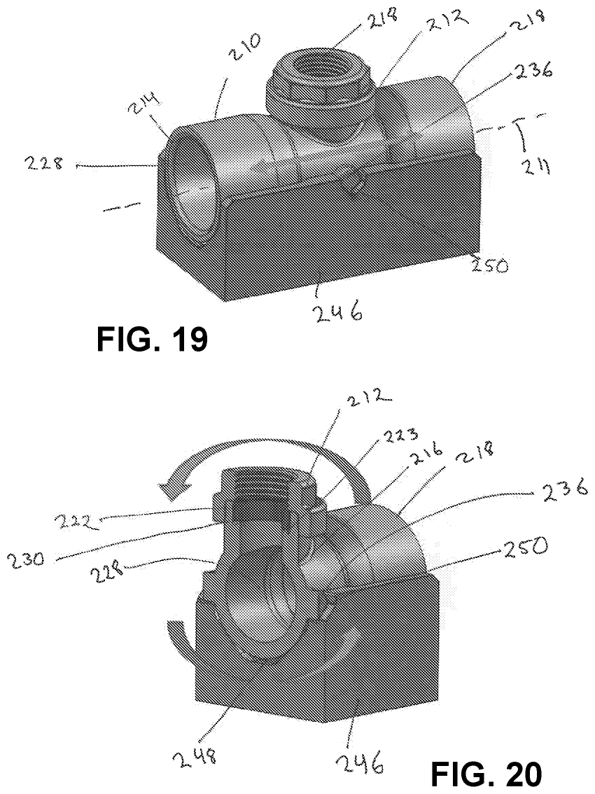

Referring now to FIGS. 18-20, an assembly fixture 246 is shown. The assembly fixture 246 can to receive and retain the sprinkler head adapter 200, as shown in FIGS. 19-20. As shown in FIG. 18, the assembly fixture includes a cavity 248, with the cavity 248 receiving the sprinkler head adapter 200. The cavity 248 can have various geometries, with the various geometries corresponding to the geometry of the sprinkler head adapter 200 such that the cavity receives and subsequently retains the sprinkler head adapter 200. The assembly fixture 246 may be implemented similarly to the assembly fixture 146 as shown and described previously. That is to say that the assembly fixture 246 may be implemented in manufacturing and/or assembly processes (for example, ultrasonic welding) so as to retain the sprinkler head adapter 200 and any components thereof in a predetermined position. The geometry of the cavity 248 facilitates said retention, as the geometry can to complement the geometry of the sprinkler head adapter 200.

The assembly fixture 246 is shown to include a pair of notches 250, which may be the same as and/or similar to the notch 150 of the assembly fixture 146 as shown and described previously. The notches 250 can in opposite sidewalls of the assembly fixture 146, and can have a complementary geometry to the one or more locator lugs 236 disposed on the exterior surface of the body 210 of the sprinkler head adapter 200. As shown, the notches 150 include a right angle, which corresponds to a right angle found on the locator lugs 236 of the sprinkler head adapter 200. However, in some aspects the locator lugs 236 may have alternate geometries and, accordingly, the notches 150 may have complementary geometries such that the notches 150 can to at least partially receive the locator lugs 236 as the sprinkler head adapter 200 is received in the cavity 248 of the assembly fixture 246. With reference to FIGS. 19-20, the assembly fixture 246 is shown to prevent movement of the sprinkler head adapter 200 while the sprinkler head adapter 200 is at least partially received by the cavity 248. In the example of FIG. 19, the locator lugs 236 can at least partially within the notches 150 and, as facilitated by the structure of the notches 150, the sprinkler head adapter 200 is retained within the cavity 248 such that movement along the central axis 211 is prevented. With reference to the example of FIG. 20, the sprinkler head adapter 200 can within the cavity 248 of the assembly fixture 146 as in the example of FIG. 19. As shown in FIG. 20, the assembly fixture 246 (in conjunction with the notches 150 thereof) prevents rotational movement of the sprinkler head adapter 200. The retention of the sprinkler head adapter 200 by the assembly fixture 246, as shown and described with reference to FIGS. 18-20, facilitates assembly and/or manufacturing procedures for the sprinkler head adapter. In retaining the sprinkler head adapter 200 and components thereof in a predetermined and desired position for such procedures, efficiency and quality of products is increased and error is decreased due to the known and constant positioning of the necessary components.

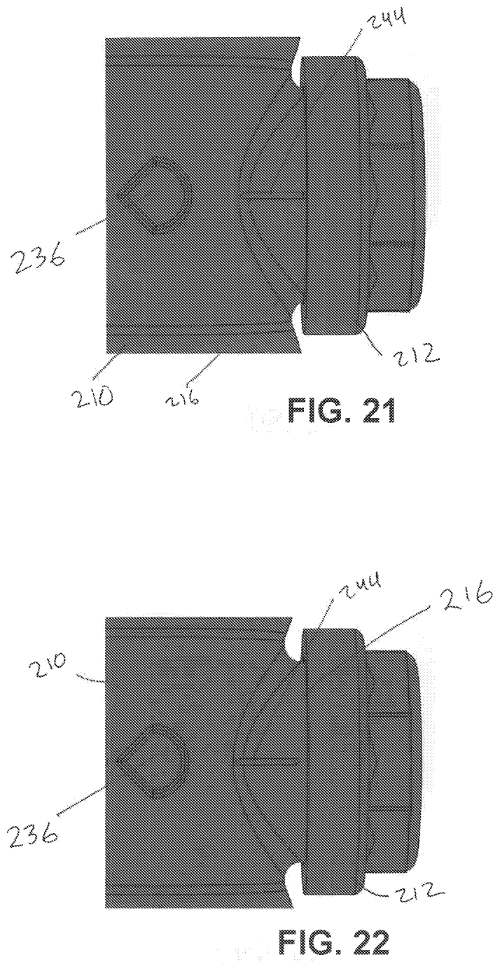

FIGS. 21-22 show the verification indicators 244 in relation to the cap 212 after the body 210 and the cap 212 have been assembled. The verification indicators 244 can similar to or the same as the verification indicators 144 of the sprinkler head adapter 100, and similarly indicate proper assembly or lack thereof between the body 210 and the cap 212. FIG. 21 shows the verification indicator 244 directly adjacent the cap 212, which is indicative of a proper assembly and allows for quick and efficient verification of a proper assembly. Conversely, FIG. 22 shows the verification indicator 244 not directly adjacent the cap 212 (e.g., a gap is observable), which is indicative of an improper assembly and allows for quick and efficient identification of a proper assembly. The identification of an improper assembly, which may result in malfunction or a lack of function, is critical and is observable by the position of the cap 212 relative to the verification indicators 244, similar to those of the sprinkler head adapter 100.

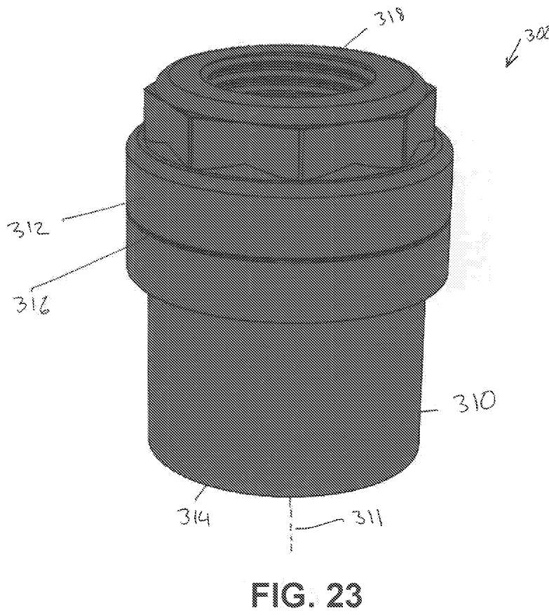

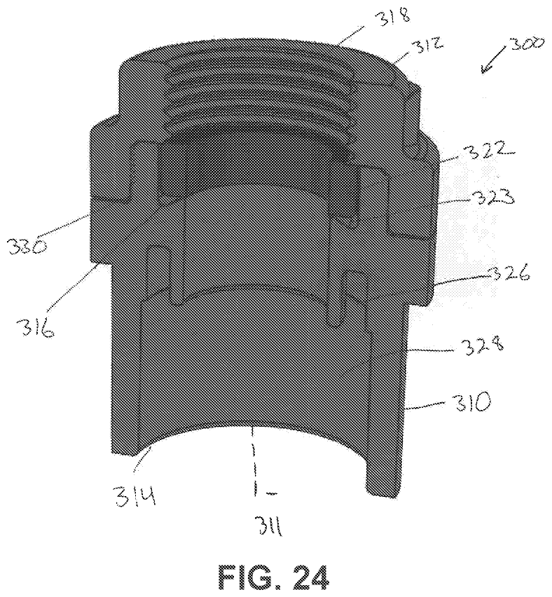

Referring now to FIGS. 23-26, a sprinkler head adapter 300 is shown. The sprinkler head adapter is shown to include a body 310 and a cap 312. The body 310 is shown to be of an elongated cylindrical geometry symmetrically about a central axis 311, and is shown to include a first opening 314 and a second opening 316 at opposite ends of the body 310. The cap 112 is shown to be coupled with the body 310, where a shear joint 330 is formed at the interface of the second opening 316 of the body 310 and the cap 312. Additionally, the cap 312 may include one or more textures or other geometry on exterior surfaces thereof so as to facilitate gripping and/or manipulation of the cap 312 by a user and/or tool. The cap 312 is coupled with the body 310 so as to assemble the sprinkler head adapter 300 using ultrasonic welding, although other techniques and processes may be implemented in some aspects.

The body 310 is shown to define a volume 328 having a substantially cylindrical geometry and centered about the central axis 311. The body 310 includes a circumferential groove 326 arranged adjacent the interior surface of the body between the first opening 314 and the second opening 316. In some aspects, a gasket can be at least partially within the circumferential groove 326 so as to prevent leakage upon coupling of the body 310 to a fluid supply line 332 and subsequent flow of fluid from the fluid supply line 332 and into the volume 328. The sprinkler head adapter 300 is shown to include a gasket 322 disposed within a gasket notch 323, with the gasket 322 and the gasket notch 323 adjacent the interface between the second opening 316 of the body 310 and the cap 312. The gasket 322 can within the gasket notch 323, with the gasket notch 323 spanning the circumference of the volume adjacent the shear joint 330. The gasket 322 is positioned between the second opening 316 of the body 310 and the cap 312 so as to prevent leakage of any fluid flowing from the fluid supply line 332 into the volume 328 of the body 310 and subsequently past the interface of the body 310 and the cap 312 to ultimately reach a sprinkler 334. In some aspects, the sprinkler 334 may be the same as or similar to the sprinkler 134 as shown and described previously. The cap 312 is shown to include a threading 318 to facilitate coupling with the sprinkler 334, which may be a ½-inch NPT fire protection sprinkler, for example. The sprinkler 334 can to have complimentary geometry to the cap 312 (e.g., threads) so as to facilitate coupling between the cap 312 of the sprinkler head adapter 300 and the sprinkler 334. In some aspects, the coupling between the cap 312 and the sprinkler 334 may include alternative coupling mechanisms including various complementary geometries, and may also implement glue, adhesive, or other bonding agents.

In many buildings, it is common for 1-inch diameter pipe to be installed for fluid supply lines (such as fluid supply line 332) to provide water or other fire suppression fluid to a system of one or more sprinklers (such as the sprinkler 334) in order to provide fire protection and/or suppression for an area. However, fittings and adapters for 1-inch pipe are bulky and often require a substantial amount of space in order to be installed and facilitate the flow of fluid from the 1-inch fluid supply line to the sprinkler. As such, the use of 1-inch pipes for fluid supply lines can present challenges in restricted areas, such as the concealed space 138 as shown and described previously. To combat the issue of bulky 1-inch pipe fittings and adapters in small spaces, 1-inch pipes (which are standard and commonly installed in many buildings) are transitioned to ¾-inch pipes to serve as fluid supply lines such as the fluid supply line 332 in contact with either a sprinkler head adapter (such as the sprinkler head adapter 300) or the sprinkler itself. Such a transition requires additional and often expensive hardware to transition the 1-inch pipes to ¾-inch pipes, and the subsequently fit the ¾-inch pipes to the sprinkler. Additionally, the reduction in pipe size from 1-inch to ¾-inch reduces potential volumetric flow rates to the sprinklers and can subsequently reduce fire protection/suppression potential. This creates a need for additional sprinkler and fluid supply line installation, which is costly.

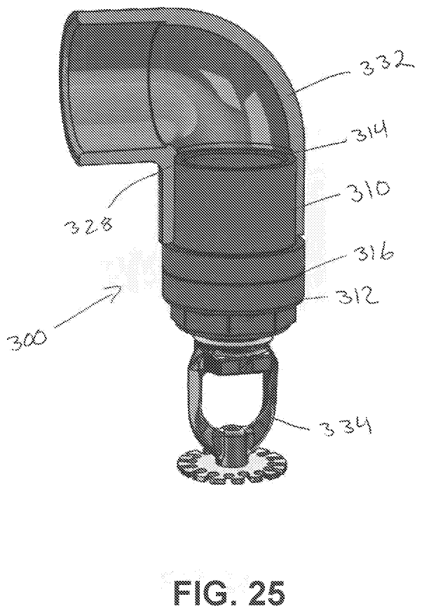

The sprinkler head adapter 300 can to accommodate both pipes having a 1-inch diameter and pipes having a ¾-inch diameter as the fluid supply lines 332. More specifically the body 310 of the sprinkler head adapter 300 can be coupled with both 1-inch diameter and ¾-inch diameter pipes. With reference to FIG. 25, the fluid supply line 332 is shown to be a 1-inch diameter pipe. As shown, the body of the sprinkler head adapter 300 (beginning with the portion adjacent the first opening 314) is shown to be received by and into the fluid supply line 332 so as to couple to the fluid supply line 332. That is to say that, in the example of FIG. 20, the sprinkler head adapter 300 functions as a male spigot, which may be inserted in various 1-inch pipes such as an elbow, tee, bushing, or other pipe or fluid supply line configurations. The exterior surface of the body 310 of the sprinkler head adapter 300 is shown to contact the interior surface of the fluid supply line 332 so as to facilitate sealing and provide fluid communication between the fluid supply line 332 and the volume 328 of the body 310 of the sprinkler head adapter 300. The sprinkler head adapter 300 is also coupled, via the cap 312, to the sprinkler 334. Accordingly, the sprinkler head adapter 300 facilitates fluid communication between the fluid supply line 332 and the sprinkler 334. By coupling the 1-inch pipe serving as the fluid supply line 332, the 1-inch pipe can provide fluid directly to the sprinkler 334 without transitioning to a pipe of a smaller diameter and thus decreasing volumetric flow potential as well as increasing possible costs for additional fixtures, adapters, and sprinklers to provide fire protection/suppression for a given space.

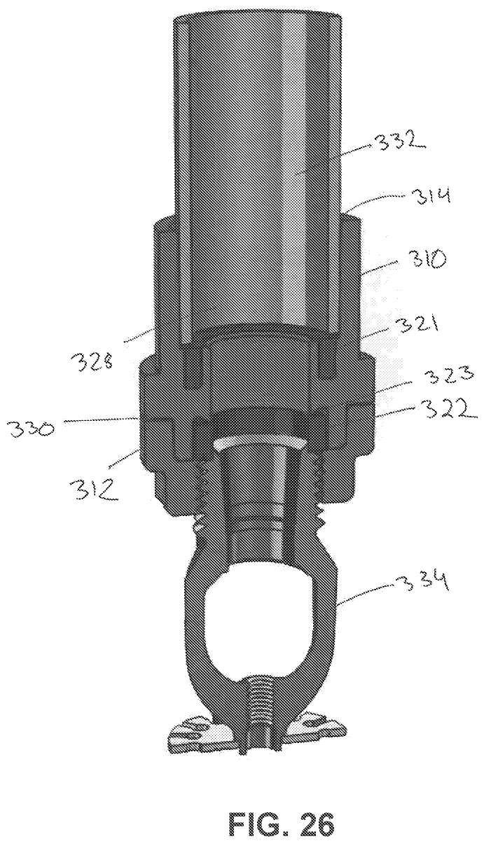

With reference to FIG. 26, the sprinkler head adapter 300 is shown to receive the fluid supply line 332 within the volume 328 of the body 310. It should be noted that the sprinkler head adapter 300 shown in FIGS. 20-21 can be the same sprinkler head adapter 300 interfacing with two different sizes of pipe used as the fluid supply line 332. In the example of FIG. 26, the fluid supply line 332 is shown to be a ¾-inch pipe with the sprinkler head adapter 300 serving as a female socket to accept the ¾-inch pipe. The example of FIG. 26 is also shown to include a gasket 321, which can adjacent the fluid supply line 332 and may be implemented in some aspects to facilitate the formation of a seal between the fluid supply line 332 and the body 310 such that fluid communication may be provided between the fluid supply line 332, the sprinkler head adapter 300, and subsequently the sprinkler 334 shown to be coupled with the cap 312 of the sprinkler head adapter 300. The body 310 is shown to be coupled with the cap 312 adjacent the shear joint 330 (with the assembly of the cap 312 and the body 310 formed using ultrasonic welding, according to some aspects). The gasket 322 is shown to be positioned within the gasket notch 323 such that the gasket 322 is retained within the sprinkler head adapter 300 and facilitates the formation of a seal between the body 310 and the cap 312 such that fluid communication is provided through the sprinkler head adapter 300 and to the sprinkler 334 such that fluid flowing via said fluid communication may be dispersed to an area to provide fire protection/suppression.

The sprinkler head adapter 300 may be manufactured and assembled according to a variety of means and/or methods. For example, the body 310 and the cap 312 may be produced using injection molding processes and techniques and may be comprised of PVC or CPVC materials. Assembly of the body 310 and the cap 312 to form the sprinkler head adapter 300 may be done using, for example, ultrasonic welding, although other assembly processes may also be implemented. One or both of the gaskets 321 and 322 may be a polyurethane material, or may also be comprised of other materials.

As utilized herein, the terms “approximately,” “about,” “substantially”, and similar terms are intended to include any given ranges or numbers+/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The construction and arrangement of the fitting assembly as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A head adapter of a fire sprinkler, comprising:
a body having a linear shape and defining a volume, the body comprising:
an open first end that couples with a fluid supply line so as to provide fluid communication between the fluid supply line and the volume of the body;
an open second end that provides fluid communication between the volume of the body and the fire sprinkler, wherein the second end comprises a gasket; and
a cap coupled with the open second end of the body such that the gasket is disposed between the cap and the volume, the cap couples the body with the fire sprinkler to provide fluid communication between the fluid supply line and the fire sprinkler, wherein the volume of the body accommodates movement of fluid from the fluid supply line to the fire sprinkler.

2. The head adapter of claim 1, comprising:
a shear joint facilitating coupling of the cap to the open second end of the body.

3. The head adapter of claim 1, comprising:
the open first end of the body comprises a diameter less than the diameter of the fluid supply line.

4. The head adapter of claim 1, comprising:
the open first end of the body comprises a diameter greater than the diameter of the fluid supply line.

5. The head adapter of claim 1, comprising:
the cap is coupled with the body by ultrasonic welding and comprises a threading for coupling to the fire sprinkler.

6. The head adapter of claim 1, comprising:
the fire sprinkler is a concealed fire sprinkler positioned within a recess of a wall.

7. The head adapter of claim 1, comprising:
the open first end of the body is coupled with the fluid supply line and the fluid supply line has a 1-inch diameter.

8. The head adapter of claim 1, comprising:
the open first end of the body is coupled with the fluid supply line and the fluid supply line has a ¾-inch diameter.

9. The head adapter of claim 1, comprising:
a third opening between the first opening and the second opening.

10. The head adapter of claim 1, comprising:
a third opening between the first opening and the second opening; and
a locator lug between the first opening and the third opening, the body reduces in diameter between the first opening and the locator lug.

11. A sprinkler assembly, comprising:
a fire sprinkler;
a fluid supply line; and
a sprinkler adapter, comprising:
a body defining a volume;
a first opening coupled with the body, the first opening couples with a fluid supply line to provide fluid communication between the fluid supply line and the volume;
a second opening coupled with the body, the second opening provides fluid communication between the volume and a fire sprinkler, the second opening comprises a gasket; and
a cap coupled with the second opening such that the gasket is disposed between the cap and the volume, the cap couples the body with the fire sprinkler to provide fluid communication between the fluid supply line and the fire sprinkler, the volume accommodates movement of fluid from the fluid supply line to the fire sprinkler.

12. The sprinkler assembly of claim 11, comprising:
a shear joint facilitating coupling of the cap to the second opening of the body.

13. The sprinkler assembly of claim 11, comprising:
the first opening comprises a diameter less than the diameter of the fluid supply line.

14. The sprinkler assembly of claim 11, comprising:
the cap is coupled with the body by ultrasonic welding and comprises a threading for coupling to the fire sprinkler.

15. The sprinkler assembly of claim 11, comprising:
the fire sprinkler is a concealed fire sprinkler positioned within a recess of a wall.

16. The sprinkler assembly of claim 11, comprising:
the first opening is coupled with the fluid supply line and the fluid supply line has a 1-inch diameter.

17. The sprinkler assembly of claim 11, comprising:
the first opening is coupled with the fluid supply line and the fluid supply line has a ¾-inch diameter.

18. The sprinkler assembly of claim 11, comprising:
a third opening between the first opening and the second opening.

19. The sprinkler assembly of claim 11, comprising:
the body comprises a third opening between the first opening and the second opening; and
a locator lug between the first opening and the third opening, the body reduces in diameter between the first opening and the locator lug.

20. The sprinkler assembly of claim 11, comprising:
at least a portion of the sprinkler extends through a wall of a building.
